(19) United States
(12) Patent Application Publication
(10) Pub. No.: US 2026/0298537 A1
(43) Pub. Date: Oct. 1, 2026

(54) OVEN FOR HEATING AN ARTICLE ON A CONVEYOR

(71) Applicant: CPM Packaging Ltd, Worsley, Manchester (GB)

(72) Inventor: Andrew Paul BUTLER, Blackburn, Lancashire (GB)

(21) Appl. No.: 19/479,349

(22) PCT Filed: Apr. 26, 2024
(86) PCT No.: PCT/GB2024/051098

§ 371 Date: Oct. 28, 2025

(30) Foreign Application Priority Data
Apr. 28, 2023 (GB) 2306373.8
Apr. 28, 2023 (GB) 2306376.1
Apr. 28, 2023 (GB) 2306381.1
Apr. 28, 2023 (GB) 2306387.8

(51) Int. Cl. F26B 15/18; F26B 3/04; F26B 21/00; F26B 21/25; F26B 21/35; F26B 21/37; F26B 21/55

(52) U.S. Cl. CPC F26B 15/18; F26B 21/001; F26B 21/25; F26B 21/35; F26B 21/37; F26B 21/55; F26B 3/04

(57) ABSTRACT

There is disclosed an oven (200) for applying heat to an article (116) on a conveyor (114), the oven (200) comprising: an air inlet (102) configured to receive an inflow of make-up air into a make-up airflow path (104); an internal circulation path (108) comprising a main heat source (109), wherein air circulates within the internal circulation path (108); and an exhaust outlet (112) configured to expel air out of the oven (200) from the internal circulation path (108)so as to control a quantity of contaminants flowing within the internal circulation path (108), wherein: the make-up airflow path (104) exits into the internal circulation path (108); and the make-up airflow path (104) comprises an electric heater (202) to provide heat to the make-up air flowing in the make-up airflow path (104) before the make-up air exits into the internal circulation path (108).

The present disclosure relates to an oven for applying heat to an article on a conveyor.

### BACKGROUND

Ovens may be used to apply heat to articles during a manufacturing process in relation to the article. For example, heat may be applied to the article to dry the article (for example, to cause water or another solvent to evaporate from the surfaces of the article) and/or to treat (using heat) a substance applied to the article. As an example, a material may be applied to the article which requires curing by the application of heat. For example, one or more lacquers may be applied to the article, which are to be cured by the application of heat.

When heat is applied to applied substances (such as lacquer), certain volatile molecules may be released and enter the air surrounding the article. Accordingly, there is a need to manage the air within ovens. In some examples, in order to generate heat, such ovens may use a form of fuel, such as natural gas. For example, the natural gas may be combusted to generate heat within the oven.

The present disclosure provides a number of improvements and/or solutions to problems in relation to such ovens.

### SUMMARY

According to a first aspect of the present disclosure, there is provided an oven for applying heat to an article on a conveyor, the oven comprising: an air inlet configured to receive an inflow of make-up air into a make-up airflow path; an internal circulation path comprising a main heat source, wherein air circulates within the internal circulation path; and an exhaust outlet configured to expel air out of the oven from the internal circulation path so as to control a quantity of contaminants flowing within the internal circulation path, wherein: the make-up airflow path exits into the internal circulation path; and the make-up airflow path comprises an electric heater to provide heat to the make-up air flowing in the make-up airflow path before the make-up air exits into the internal circulation path.

Optionally, the main heat source is a gas burner chamber in the internal circulation path through which the circulating air passes.

Optionally, the gas burner chamber is supplied with a fuel gas comprising hydrogen gas, and the gas burner chamber is configured to generate a flame exposed to the circulating air.

Optionally, the fuel gas is a mixture of hydrogen gas and natural gas, or the fuel gas is a mixture of hydrogen gas and liquid petroleum gas.

Optionally, the electric heater is controlled to provide heat directly to the make-up air such that the make-up air is at a temperature higher than ambient temperature before the make-up air exits into the internal circulation path.

Optionally, the make-up airflow path comprises a make-up airflow generator configured to urge the inflow of make-up air via the air inlet.

Optionally, the make-up airflow generator is configured to urge the inflow of make-up air at a flow rate so as to replace the air expelled from the exhaust outlet.

Optionally, the make-up airflow generator is configured to be controlled to provide a temperature normalized inlet flow rate of the inflow being received at the air inlet, which is the same as, or similar to a temperature normalized exhaust flow rate of air being expelled via the exhaust outlet.

Optionally, the oven comprises an exhaust airflow detector configured to detect one or more parameters indicative of the air flow of air being expelled via the exhaust outlet; and an exhaust airflow temperature detector configured to detect one or more parameters indicative of the temperature of air being expelled via the exhaust outlet, wherein, the temperature normalized exhaust flow rate is determined based on the one or more parameters detected by the exhaust airflow detector, and the one or more parameters detected by the exhaust airflow temperature detector.

Optionally, the oven comprises: an inlet airflow detector configured to detect one or more parameters indicative of the air flow of the inflowing air being received at the air inlet; and an inlet airflow temperature detector configured to detect one or more parameters indicative of the temperature of air being received at the air inlet, wherein, the temperature normalized inlet flow rate is determined based on the one or more parameters detected by the inlet airflow detector, and the one or more parameters detected by the inlet airflow temperature detector.

Optionally, the make-up airflow path comprises a set of make-up air outlets configured to provide make-up air from the make-up airflow path to a first location within the oven that is part of the internal circulation path and/or a second location within the oven that is part of the internal circulation path, to thereby provide for the make-up airflow path to exit into the internal circulation path, wherein: the first location is towards an entry point of the conveyor into a heated zone of the oven, and the second location is towards an exit point of the conveyor from the heated zone.

Optionally, the set of make-up air outlets comprises one or more nozzles configured to direct the make-up air onto the conveyor.

Optionally, the make-up air exiting via the set of make-up air outlets towards the first and/or second location generates an air pressure at, or close to the first location and/or the second location, respectively, which is greater than the ambient air pressure outside of the oven.

Optionally, the air inlet is a first air inlet, and the oven comprises a second air inlet configured to receive an inflow of make-up air into the make-up air flow path; and the make-up air flow path comprises a first make-up air passageway which receives make-up air from the first air inlet, and a second make-up air passageway which receives make-up air from the second air inlet.

Optionally, the set of make-up air outlets is configured to provide make-up air from the make-up airflow path to both the first location and to the second location; and the first make-up air passageway leads to the first location and the second make-up air passageway leads to the second location.

Optionally, the make-up airflow path comprises: a set of make-up air outlets to allow the make-up air to exit the make-up airflow path, the set of make-up air outlets comprising: one or more nozzles configured to direct the make-up air onto the conveyor; and an internal circulation path inlet configured to receive make-up air from the make-up airflow path at a location along the internal circulation path such that the make-up air mixes with the circulating air before being projected towards the conveyor, and the make-up airflow path comprises a valve configured to control an amount of make-up air allowed to enter the internal circulation path via the internal circulation path inlet.

Optionally, the oven comprises: a nozzle temperature detector positioned upstream of the one or more nozzles and configured to detect one or more parameters indicative of the temperature of the make-up air passing through the one or more nozzles; and a nozzle airflow detector positioned upstream of the one or more nozzles and configured to detect one or more parameters indicative of the air flow of the make-up air approaching the one or more nozzles.

Optionally, the valve is controlled based on a nozzle speed of the make-up air passing through the one or more nozzles, wherein the nozzle speed is determined based on the one or more parameters detected by the nozzle temperature detector, and the one or more parameters detected by the nozzle airflow detector.

Optionally, the valve is controlled such that the nozzle speed does not exceed a nozzle speed threshold.

Optionally, the nozzle speed threshold is between 4 m/s and 11 m/s.

According to a second aspect of the present disclosure, there is provided an oven system for applying heat to an article on a conveyor, the oven system comprising: a plurality of ovens according to the first aspect; and a conveyor configured to convey the article in a first direction, wherein: the plurality of ovens are arranged linearly along the first direction; and the conveyor is configured to convey the article through a respective heated zone of each of the plurality of ovens.

According to a third aspect of the present disclosure, there is provided a method for drying an article, and/or curing lacquer applied to an article, the method comprising: conveying the article on a conveyor through an oven, the oven comprising: an air inlet configured to receive an inflow of make-up air into a make-up airflow path; an internal circulation path comprising a main heat source, wherein air circulates within the internal circulation path; and an exhaust outlet configured to expel air out of the oven from the internal circulation path so as to control a quantity of contaminants flowing within the internal circulation path, wherein: the make-up airflow path exits into the internal circulation path; and the make-up airflow path comprises an electric heater to provide heat to the make-up air flowing in the make-up airflow path before the make-up air exits into the internal circulation path; and operating the electric heater to provide heat to the make-up air being received through the air inlet, before the make-up air exits into the internal circulation path.

Optionally, in the method according to the third aspect, the make-up airflow path of the oven comprises a make-up airflow generator configured to urge the inflow of make-up air via the air inlet at a flow rate so as to replace the air expelled from the exhaust outlet; and the method comprises operating the make-up airflow generator to provide a flow rate of the make-up air so as to replace the air being expelled, in use, from the exhaust outlet.

Optionally, in the method according to the third aspect, the make-up airflow path of the oven comprises a set of make-up air outlets configured to provide make-up air from the make-up airflow path to a first location within the oven that is part of the internal circulation path and/or a second location within the oven that is part of the internal circulation path, to thereby provide for the make-up airflow path to exit into the internal circulation path, wherein: the first location is towards an entry point of the conveyor into a heated zone of the oven, and the second location is towards an exit point of the conveyor from the heated zone; and the method comprises operating the oven to provide, using the set of make-up air outlets, the make-up air from the make-up airflow path to the first location and/or the second location.

Optionally, in the method according to the third aspect, the make-up airflow path of the oven comprises: a set of make-up air outlets to allow the make-up air to exit the make-up airflow path, the set of make-up air outlets comprising: one or more nozzles configured to direct the make-up air onto the conveyor; and an internal circulation path inlet configured to receive make-up air from the make-up airflow path at a location along the internal circulation path such that the make-up air mixes with the circulating air before being projected towards the conveyor, and the make-up airflow path of the oven comprises a valve configured to control an amount of make-up air allowed to enter the internal circulation path via the internal circulation path inlet, the method further comprising: controlling a nozzle speed of the make-up air passing through the one or more nozzles by controlling the valve.

### BRIEF DESCRIPTION OF THE DRAWINGS

Examples of the present disclosure will now be described with reference to the accompanying drawings, in which:

FIG. 1 is a simplified schematic sketch on an oven, according to examples;

FIG. 2 is a simplified schematic sketch of a first example of the oven of FIG. 1, according to a first set of examples;

FIG. 3 is a simplified schematic sketch of a second example of the oven of FIG. 1, according to a second set of examples;

FIGS. 4A, 4B and 4C are simplified schematic sketches of a third example of the oven of FIG. 1, according to a third set of example;

FIG. 5 is a simplified schematic sketch of a fourth example of the oven of FIG. 1, according to a fourth set of examples;

FIG. 6 is a simplified schematic sketch of an oven system, according to examples;

FIG. 7 is a flow diagram illustrating aspect of a first method, according to the first set of examples;

FIG. 8 is a flow diagram illustrating aspect of a second method, according to the second set of examples;

FIG. 9 is a flow diagram illustrating aspect of a third method, according to the third set of examples; and

FIG. 10 is a flow diagram illustrating aspect of a first method, according to the first set of examples.

### DETAILED DESCRIPTION

The present disclosure relates to an oven for applying heat to an article on a conveyor. In examples, the oven comprises an air inlet configured to receive an inflow of make-up airflow path. According to examples, the oven comprises an internal circulation path comprising a main heat source, wherein air circulates within the internal circulation path, and an exhaust outlet configured to expel air out of the oven from the internal circulation path so as to control a quantity of contaminants flowing within the internal circulation path. For example, the main heat source provides heat to the circulating air circulating within the internal circulation path. Various, more specific examples of the disclosed oven are discussed hereafter.

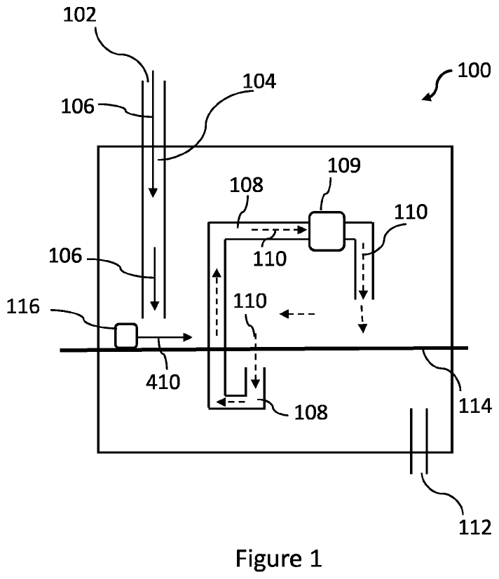

FIG. 1 is a simplified schematic sketch of the oven 100, according to examples. the oven 100 comprises air inlet 102, which is configured to receive an inflow of make-up air into the make-up airflow path 104. In the examples of FIG. 1, the flow of the make-up air flowing within the make-up airflow path 104 is indicated by solid arrows 106. In the examples of FIG. 1, the make-up airflow path 104 is indicate as a single passageway. However, in some examples, the make-up airflow path 104 may comprise a plurality of different passageways together forming the make-up airflow path 104.

In these examples, the oven 100 comprises the internal circulation path 108 comprising the main heat source 109. The existing air within the oven 100 circulates within the internal circulation path 108. In other words, the internal circulation path 108 is for the circulation of air within the oven 100. In other words, the internal circulation path 108 provides for the flow of air within the oven 100 between different regions of the oven 100 in a cyclical manner. In the present description, the term “circulating air” is used to refer to the air circulating within the internal circulation path 108. The flow of the circulating air within the internal circulation path 108 is roughly indicated by the dashed arrows 110.

Those skilled in the art will appreciate that ovens comprise a heat source. For example, in the case of the kinds of oven referred to herein, there is typically a heat source which maintains the air circulating in the internal circulation path 108 at (or relatively close to) a desired temperature. In these examples, the main heat source 109 provides heat to the circulating air to maintain a desired temperature of the circulating air.

In these examples, the oven 100 comprises the exhaust outlet 112. The exhaust outlet 112 is configured to expel air out of the oven 100 from the internal circulation path 108. Reference may be made herein to the “circulating air” being exhaust or the “exhausted air”. It should be appreciated that in either case, what is being referred to is the exhausting of air within the oven 100 which exists within the internal circulation path 108.

In these examples, there is shown a conveyor 114. For example, the article 116 may be conveyed through the oven 100 on the conveyor 114. For example, the oven 100 may comprise a body 406, inside which certain parts of the oven 100 are housed. Inside the body 406, there may be a heated zone 408. The heated zone 408 is where articles are intended to be positioned in order to be heated by the oven 100. For example, the heated zone 408 is part of the internal circulation path 108. For example, the internal circulation path 108 may comprise one or more passages which guide the circulating air. The one or more passages of the internal circulation path 108 may exit into and receive circulating air from the heated zone 408. For example, the conveyor 114 is positioned in the heated zone 408 such that articles being conveyed on the conveyor 114 are heated when in the heated zone 408.

For example, the conveyor 114 may be in the form of a belt conveyor, a conveyor comprising roller, and the like. Those skilled in the art will appreciate the various types of conveyors which can be used to move articles from one location to another during a manufacturing process. For example, with a portion of the conveyor 114 positioned in the heated zone 408, a belt of the conveyor may move relative oven 100 so as to transport the article 116 through the oven 100 in a transport direction 410.

As described, the oven 100 is for applying heat to the article 116, for example. There may be applied one or more substances on the article 116 which react to the heat applied by the oven 100, and the oven 100 may be intended for applying heat to such articles. In some examples, there is one or more substances applied on the article 116 which release contaminant(s) into the air in the region of the article 116. For example, the exhaust outlet 112 is configured to expel air from the internal circulation path 108 so as to control a quantity of contaminants flowing within the internal circulation path 108.

For example, air is taken out of the internal circulation path 108 when air is exhausted via the exhaust outlet 112. Accordingly, at least some of the contaminant molecules which may have been added to the air circulating in the internal circulation path 108 can thereby be removed.

As described, some of the circulating air may be exhausted so as to control the quantity of one or more contaminants flowing within the internal circulation path 108. In some examples, the amount of circulating air which should be exhausted may be determined based on an explosion limit calculation. For example, an explosion limit calculation may be performed to determine a contaminant threshold for the quantity (or concentration) of contaminant(s) which may be tolerated within the internal circulation path 108 without the risk of an explosion becoming undesirably/unacceptably high. The oven may then be controlled such that the contaminant threshold is not exceeded. For example, the explosion limit calculation may be based on the weight of one or more solvents present on the article 116 entering the oven, and the number of such articles entering the oven per unit time. For example, the contaminant(s) are introduced into the internal circulation path 108 due to evaporation of the one or more solvents inside the oven.

For example, the amount of circulating air that is exhausted may be controlled such that the contaminant threshold is not exceeded. For example, one or more dampers in the path of the circulating air being exhausted may be controlled such that the contaminant threshold. Alternatively, or in addition, an exhaust airflow generator may be provided and controlled such that enough of the circulating air is exhaust so as to not exceed the contaminant threshold.

For example, replacement of the lost air with make-up air (which does not contain contaminant(s) prior to mixing with the circulating air) also helps to control the concentration of the contaminant(s) so as to assist in not exceeding the contaminant threshold. Reference is made herein to “make-up” air. In examples, make-up air may be any gas suitable for use within the oven 100 which does not contain any significant quantity of the contaminant(s) that may exist in the internal circulation path 108 during use. For example, the make-up air may simply be fresh air from the environment outside of the oven 100. In some examples, the make-up air may be taken from an outdoor space and fed to the inlet 102 of the oven 100. In some examples, the make-up air may be air having a particular composition. For example, the make-up air with the particular composition may be stored (for example in gas storage vessels) and then fed into the oven 100. The type of make-up air used may depend in the type of operation for which the oven is being used, the type of article being treated, the type of substance(s) coating the article, etc.

For example, when air is removed by being exhausted via the exhaust outlet 112, it may be desired that replacement air is put into the oven 100 to take its place within the internal circulation path 108. This replacement air is what is referred to herein as the “make-up” air, and it is drawn in via the air inlet 102.

In these examples, the make-up airflow path 104 exits into the internal circulation path 108. For example, the make-up airflow path 104 exits into a region of the oven 100 where air circulating within the internal circulation path 108 is present. For example, after the make-up air exits the make-up airflow path 104, it mixes with the air which is circulating within the internal circulation path 108. For example, the make-up air exiting into the internal circulation path 108 includes the make-up air being supplied directly into the heated zone 408 (for example being directed onto the conveyor 114 directly before it has any significant chance to mix with the circulating air).

In some examples, the purpose of the oven 100 is apply heat to article on which there is present one or more substances. For example, the article 116 is an article to which one or more lacquers have been applied. For example, the oven 100 may function to dry the article 116 by causing one or more substances (such as water or other solvent(s)) to evaporate. For example, the oven 100 may function to cure, or partially cure the one or more lacquers applied to the article 100.

In some examples, the article 116 is a food container such as a can. The article 116 may comprise various materials used for such containers, for example, aluminium. However, the article 116 may be any kind of article to which it may be desired to apply heat during a manufacturing process, and is not limited to food containers specifically.

In some examples, the oven 100 comprises one or more processors (not shown in FIG. 1) in communication with one or more components of the oven 100. Alternatively, or in addition, there may be provided a control system external comprising one or more processors which control system is external to the oven 100. For example, the one or more processors may be configured to communicate data to and/or from one or more components of the oven 100. For example, the one or more processors may be configured to communicate control signals to one or more components of the oven 100. For example, the one or more processors may be configured to receive detection signals from one or more components of the oven 100. In the following description (for brevity and simplicity of description), reference is made to a single processor performing certain tasks.

For example, the processor is in data communication with a computer readable memory having stored thereon instructions, which when executed by the processor, cause the processor to perform certain tasks according to the examples described here. Said computer readable memory may be for long term storage of data, for example, a hard disk drive, a flash memory, solid state drive, Electrically Erasable Programmable Read-Only Memory (EEPROM), Erasable Programmable Read-Only Memory (EPROM), and the like.

For example, the processor is also in data communication with a form of non-transitory computer readable memory such as random access memory (RAM) for short term storage of data for the purpose of performing operations. Those skilled in the art will appreciate how a processor may be configured with other data processing components in order to function to provide functionality in relation to the described examples. For example, the processor controls the amount of circulating air that is exhausted as described above by communicating with/exchanging signals with the appropriate component(s) of the oven 100 (such as an exhaust fan, relevant detectors and the like).

It should be noted that various flow paths are referred to herein. A particular flow path may comprise one passageway for air to flow, or may comprise a plurality of passageways. The plurality of passageways may share inlets and/or outlets, or may have separate respective inlets and/or outlets.

More specific examples of the oven 100 are discussed in the following. In the description of the following examples, the same reference numerals are used for like features

### First Set of Examples

The first set of examples are more specific versions of the examples described previously in relation to FIG. 1. In addition to the features previously discussed, in the oven according to the first set of examples, the make-up airflow path 104 comprises an electric heater to provide heat to the make-up air flowing in the make-up airflow path before the make-up air exits into the internal circulation path 108.

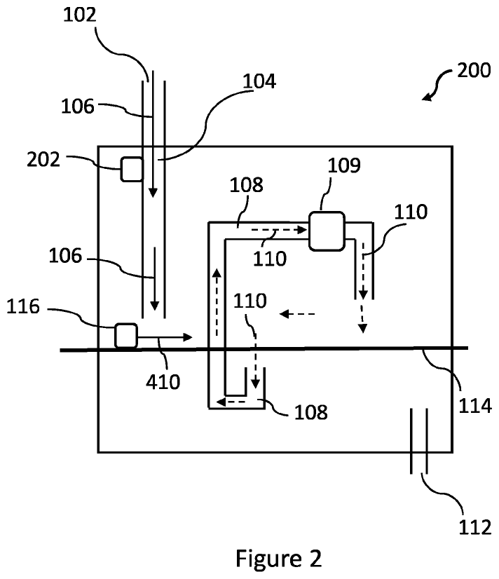

FIG. 2 is a simplified schematic sketch of a first oven 200, according to the first set of examples. The first oven 200 represents more specific examples of the oven 100 shown in FIG. 1.

In the examples of FIG. 2, there is provided the electric heater 202. In these examples, the electric heater 202 is positioned relative to the make-up airflow path 104 such that it provides heat to the make-up air upstream of any location where the make-up air joins the internal circulation path 108.

As previously described, there is provided the main heat source 109 for providing heat to the circulating air. In these examples, the electric heater 202 is a supplementary heat source. In these examples, the electric heater 202 provides heat directly to the make-up air. For example, the electric heater 202 is configured to pre-heat the make-up air, before the make-up air mixes with the circulating air. For example, the electric heater 202 is controlled to provide heat directly to the make-up air such that the make-up air is at a temperature higher than ambient temperature before the make-up air exits into the internal circulation path 108.

Advantageously, this means that less heat needs to be provided to the circulating air to maintain a particular temperature as make-up air is added to the circulating air. For example, pre-heating the make-up air using the electric heater 202 reduces the demand on the main heat source 109. For example, if the make-up air is not pre-heated and mixed with the circulating air, the main heat source 109 would be required to provide more heat per unit time to maintain the circulating air at a particular temperature. On the other hand, if the temperature of the make-up air is higher (due to the operation of the electric heater 202) before it is mixed with the circulating air, then the main heat source 109 needs to provide comparably less heat per unit time to the circulating air to maintain the same temperature.

In some examples, the main heat source 109 is a gas burner chamber in the internal circulation path 108 through which the circulating air passes. For example, the gas burner chamber 109 combusts a fuel gas (which may be a mixture of gases) in order to generate heat.

For example, providing the electric heater 202, which reduces the demand on the gas burner chamber 109, advantageously means that the gas burner chamber 109 consumes less fuel gas during operation. Accordingly, the first oven 200 according to these examples, requires a smaller quantity of fuel for the gas burner chamber 109 to be used. The first oven 200 may be referred to as a hybrid oven. For example, the first oven 200 is a hybrid oven in the sense that the first oven 200 utilises two different types of energy source in order to provide heat. In these particular examples, the first oven 200 utilises electricity and a fuel gas.

The electric heater 202 may be a resistive heater. For example, the electric heater 202 comprises a conductive element which generates heat in response to a current flow in said conductive component. In some other examples, the electric heater may be a convection heater. In some examples, the electric heater may be an inline duct heater.

As described, the electric heater 202 provides heat to the make-up air before the make-up air exits into the internal circulation path 108. Also, as described above, there may be contaminant(s) mixed in with the circulating air flowing within the internal circulation path 108. For example, inserting an electric heater into an airflow path may provide physical features (e.g., particular surface areas) on which particles from the air circulating within said path may be deposited and build up. It may not be desired to provide such physical features in the internal circulation path 108 so that deposition and build-up of the contaminant(s) is avoided. For example, such deposition and build up may adversely affect the operation of the oven. As previously described, circulating air may be exhausted on the basis of an explosion limit calculation because the contaminant(s) may be volatile. In some examples, the contaminant(s) may be undesirable in the sense that if they build up past a threshold on such physical features, the risk of an uncontrolled reaction (such as an explosion) may increase.

Advantageously, positioning the electric heater 202 in the described manner to provide heat to the make-up air before it has the opportunity to mix with the circulating air means that additional physical features are not added to the flow path of the air containing contaminant(s), while still providing the advantages of adding an electrical heat source.

In some examples, the gas burner chamber 109 is supplied with a fuel gas comprising hydrogen gas, and the gas burner chamber 109 is configured to generate a flame exposed to the circulating air. For example, the gas burner chamber 109 forms a region of the internal circulation path 108 so that the gas burner chamber 109 receives the circulating air, imparts heat to the received circulating air, and releases the heater air into the remainder of the internal circulation path 108.

In some such examples, the fuel gas is a mixture of hydrogen gas and natural gas or the fuel gas is a mixture of hydrogen gas and liquid petroleum gas. On the other hand, in some examples, the fuel gas comprises hydrogen gas and does not comprise natural gas. Advantageously, the use of hydrogen gas means that carbon emissions associated with the use of the first oven 200 is reduced. For example, if the fuel gas comprises only natural gas (the combustion of which contributes to carbon emissions), the carbon emissions are higher as compared to the case where hydrogen gas is incorporated in the fuel gas.

Those skilled in the art will appreciate that there is a greater cost associated with hydrogen gas. For example, skilled person appreciates that the cost of obtaining hydrogen gas is higher compared to the cost of obtaining natural gas. For example, while operational costs associated with the use of hydrogen gas may be lower in some cases, there are greater capital costs associated with the hydrogen gas. The skilled person also appreciates that there may be logistical difficulties associated with obtain hydrogen gas (for example, relating to supply in particular quantities, transport of hydrogen gas, storage of hydrogen gas, etc.). However, if a smaller quantity of hydrogen gas is required for a given use case, then use of hydrogen gas becomes more viable. For example, the described barriers to the use of hydrogen gas may be less significant (less adverse) for smaller quantities of hydrogen gas as compared to larger quantities. The first oven 200 according to these examples, reduces the quantity of fuel gas required to be consumed by the gas burner chamber 109. This reduction makes the use of hydrogen gas more viable in these examples.

Accordingly, the first oven 200 comprising the electric heater 202 in the described manner provides for more viable use of hydrogen gas within the fuel gas used for the main heat source 109. The first oven 200 is “hybrid” in the sense that it makes use of an electric heat source and another heat source which combusts a fuel.

In some examples, the make-up airflow path 104 comprises a make-up airflow generator (not shown in FIG. 2) configured to urge the inflow of make-up air via the air inlet 102. For example, providing the make-up airflow generator may provide for control over how much make-up air is added into the internal circulation path 108. For example, when more make-up air is desired, the make-up airflow generator may be operated to urge more make-up air to flow in via the air inlet 102. For example, by operation of the make-up airflow generator, make-up air may be actively pushed into the make-up airflow path 104. In some examples, the make-up airflow generator is component that generates airflow by virtue of physical motion (such as rotation-for example, the make-up airflow generator is a fan)

The features described in respect of the first set of examples may be combined with any other feature described herein, for example.

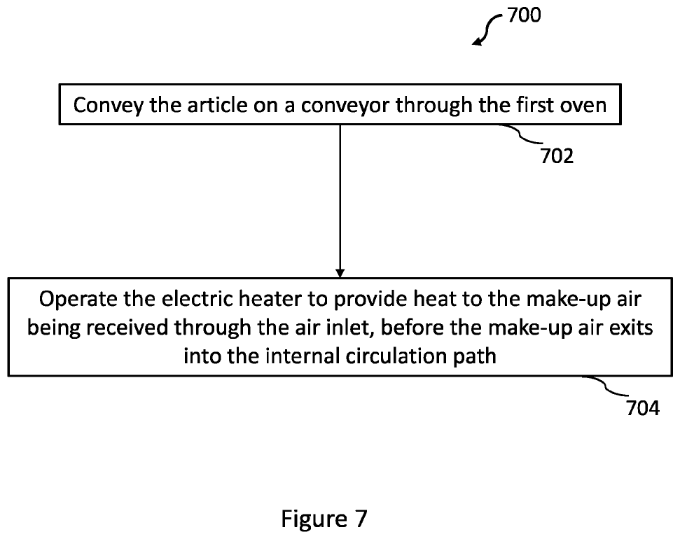

There may be provided a method, according to the first set of examples. For example, the method according to the first set of examples is for is for drying an article, and/or curing lacquer applied to an article (such as the article 116, for example). For example, the method may be for simply drying water present on the article. For example, the method may be for drying the article by removing (e.g., evaporating) other solvents off of the article. For example, the method may be for curing the lacquer. FIG. 7 is a flow diagram illustrating aspects of the first method 700 according to the first set of examples. At block 702 of the first method 700, the article 116 is conveyed on the conveyor 114 through the first oven 200. In these examples of the first method 700, the first oven 200 according to the first set of examples is used. In other words, in these examples, an oven comprising the descried electric heater 202 is used. At block 704 of the first method 700, the electric heater 202 is operated to provide heat to the make-up air being received through the air inlet 102, before the make-up air exits into the internal circulation path 108.

In this manner, there is provided a method of heating the make-up air to be supplied to the internal circulation path 108 so as to provide pre-heating. The use of the first method 700, for example, provides the advantages discussed above in relation to the first oven 200.

### Second Set of Examples

The second set of examples are more specific versions of the examples described previously in relation to FIG. 1. In some examples, the features of the second set of examples may also be combined with the features described in relation to the first set of examples. In these examples, in addition to the features previously discussed in relation to FIG. 1, the make-up airflow generator is configured to urge the inflow of make-up air via the air inlet 102 at a flow rate so as to replace the air expelled from the exhaust outlet 112.

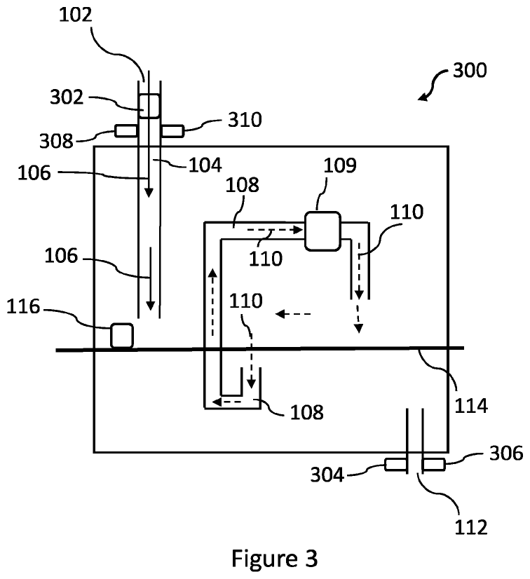

FIG. 3 is a simplified schematic sketch of a second oven 300, according to the second set of examples. The second oven 300 represents more specific examples of the oven 100 shown in FIG. 1.

In the examples of FIG. 3, there is provided the make-up airflow generator 302. As previously described, in some examples, the make-up airflow generator 302 comprises a fan configured to urge air from outside of the second oven 300 to enter the air inlet 102. For example, the make-up airflow generator 302 is configured to be controlled such that the intensity with which it urges make-up air to enter the air inlet 102 may be varied. For example, the rotation speed of the fan may be controlled in accordance with the amount of air expelled from the exhaust outlet 112.

As an example, the make-up airflow generator 302 may be controlled by the described processor (provided as part of the second oven 300, or externally, for example). In some examples, the make-up airflow generator 302 is configured to be controlled to provide a temperature normalized inlet flow rate of the inflow being received at the air inlet 102, which is the same as, or similar to a temperature normalized exhaust flow rate of air being expelled via the exhaust outlet 112. For example, the make-up airflow generator 302 is configured such that it can provide, and be controlled to provide, a temperature normalized inlet flow rate appropriate for replacing, within the second oven 300, the air which is lost via the exhaust outlet 112. It will be appreciated that, for example, a fan can be selected to move a desired quantity of air per unit time depending on rotation speed range, size, and other operation features, for example.

In these examples, a temperature normalized flow rate refers to a flow rate of airflow which has been normalized by the temperature of said air. Those skilled in the art will appreciate that a flow rate corresponds to a volume of air moving per unit time and may be expressed in units of m³/s (for example, speed of airflow multiplied by an area through which the air is passing). For example, the density of the air (in the sense of the number of molecules of the air per unit volume of the air) may vary depending on temperature. For example, hotter air may be less dense and colder air may be more dense in comparison. Therefore, a flow rate of the airflow may mean a different amount of air (e.g., a different quantity of the molecules of the air) flowing past a certain point depending on the temperature of the air.

For example, if the temperature of the air in question is known, a flow rate value associated with said air may be normalized according to that temperature to yield a temperature normalized flow rate. For example, the temperature normalized flow rates may be compared irrespective of the temperature to provide information about the quantities of air entering or leaving from the second oven 300. In some examples, the following equation is used to determine a temperature normalized flow rate.

$$Qn = Qt \times \frac{273}{273 \times T} \qquad ( 1 )$$

In Equation (1) above, Qn represents the temperature normalized flow rate, Qt represents the actual flow rate (not normalized by temperature), and T represents the actual temperature.

For example, the temperature normalized exhaust flow rate provides an indication of an amount of circulating air (e.g., the number of moles of the circulating air, or the number of molecules of the circulating air) leaving the second oven 300 via the exhaust outlet 112. In order that a desired amount of air remains circulating within the second oven 300 in the internal circulation path 108, the lost air is replaced by the make-up air flowing in via the air inlet 102. Controlling the make-up airflow generator 302 in the described manner provides for control over the inflow of the make-up air so that the appropriate quantity of make-up air is input to replace the circulating air which has been exhausted.

For example, if the temperature normalized inlet flow rate is the same as (or similar to) the temperature normalized exhaust flow rate, then, irrespective of any temperature difference between the incoming make-up air and the outgoing exhausted air, the amount of make-up air (in the sense of number of moles, or quantity of molecules, etc.) being taken in is the same as (or similar to) the amount of exhausted air (in the sense of number of moles, or quantity of molecules, etc.).

In some examples, the temperature normalized exhaust flow rate of the circulating air being exhausted is determined. For example, the temperature normalized exhaust flow rate may be determined based on measurements taken on the circulating air being exhausted (for example, as it is exhausted).

In some examples, the second oven 300 comprises an exhaust airflow detector 304 configured to detect one or more parameters indicative of the air flow of air being expelled via the exhaust outlet 112. For example, the exhaust airflow detector 304 is positioned appropriately in relation to the exhaust outlet 112 so as to be able to detect the one or more parameters associated with air being expelled from the exhaust outlet 112.

In some examples, the second oven 300 comprises an exhaust airflow temperature detector 306 configured to detect one or more parameters indicative of the temperature of air being expelled via the exhaust outlet 112. For example, the exhaust airflow temperature detector 306 is positioned appropriately so as to measure the temperature of the air for which the exhaust airflow detector 304 measures the respective one or more parameters. In other words, both of these detectors 304, 306 make measurements with respect to the same air. In this manner the speed and temperature measurements correspond to one another.

In some examples, the exhaust airflow detector 304 is a differential pressure sensor for measuring static pressure and velocity pressure (examples of the respective one or more parameters detected by the exhaust airflow detector 304), which can then be used to determine total pressure associated with air flowing through the exhaust outlet 112. Having determined the total pressure, the velocity of the air flowing through the exhaust outlet 112 can then be determined using a dynamic pressure calculation. It will be appreciated that the temperature of the air flowing through the exhaust outlet 112 is known by virtue of the exhaust airflow temperature detector 306, and the density of said air can therefore also be determined and used in relevant calculations. Using the determined velocity in combination with a size (e.g., diameter) of the exhaust outlet 112 (or ducts associated with the exhaust outlet 112, as appropriate), a volume of air per unit time being exhaust can be determined (in other words, the exhaust flow rate can be determined).

In these examples, the temperature normalized exhaust flow rate is determined based on the one or more parameters detected by the exhaust airflow detector, and the one or more parameters detected by the exhaust airflow temperature detector. In other words, the air flow of the exhausted air is determined in the manner described above, and said airflow is normalized according to Equation (1) above to arrive at the temperature normalized exhaust flow rate.

For example, the exhaust airflow detector 304 is in communication with the described processor. For example, the exhaust airflow temperature detector 306 is in communication with the described processor. The processor may receive the one or more parameters detected by the exhaust airflow detector 304, and the one or more parameters detected by the exhaust airflow temperature detector 306. The processor may then use these parameters to determine the temperature normalized exhaust flow rate. Those skilled in the art will appreciate the various parameters which may be indicative of temperature (for example, a resistance of a circuit component in a resistive temperature detector which measures temperature based on changes in resistance).

Accordingly, there may be determined an indication of how much air is being exhausted through the exhaust outlet 112. As described above, the amount of circulating air which should be exhausted may be determined based on an explosion limit calculation. For example, the processor controls the amount of air exhaust according to the explosion limit calculation as described. Using the exhaust airflow detector 304 and the exhaust airflow temperature detector 306 may additionally allow for greater control over the amount of circulating air exhausted in order to remain below thresholds associated with the explosion limit calculation, for example.

The processor may then communicate with the make-up airflow generator 302 to operate the make-up airflow generator 302 to produce the same (or similar) temperature normalized inlet flow rate so that the exhausted air is replaced rather than the circulating air being depleted.

For example, the processor sends a control signal to the make-up airflow generator 302 in order for the make-up airflow generator 302 to produce the same/similar temperature normalized inlet flow rate. In some examples, the processor may have access to pre-determined signals to be sent to the make-up airflow generator 302 depending on the desired temperature normalized inlet flow rate. For example, the processor may access data indicating a correspondence between a control signal to be sent to the make-up airflow generator 302 and the temperature normalized flow rate provided by the make-up airflow generator 302 in response to said signal. The processor may then determine the appropriate signal according to said data and the desired temperature normalized flow rate and send that signal to the make-up airflow generator 302. As an example, the processor controls an amount of electrical power to be supplied to the fan (which is the make-up airflow generator 302, for example).

In some examples, the second oven 300 may not comprise the exhaust airflow detector 304 and the exhaust airflow temperature detector 306. As described above, the processor may control the amount of circulating air being exhausted in other ways. For example, a temperature normalized exhaust flow rate may be determined based on how the exhausting of the circulating air is being controlled. For example, there may be provided an exhaust airflow generator (such as an exhaust fan-not shown in FIG. 3) to urge some of the circulating air to be expelled via the exhaust outlet 112. For example, the temperature normalized exhaust flow rate may be determined based on the operation of the exhaust airflow generator. For example, the processor may determine the temperature normalized exhaust flow rate based on the temperature to which the circulating air is being maintained and the intensity with which the exhaust airflow generator is being driven. For example the processor may perform control to drive the exhaust airflow generator such that the associated exhaust flow rate corresponds to a desired exhaust flow rate to maintain the system with the contaminant threshold.

Alternatively, or in addition, the second oven 300 may comprise an inlet airflow detector 308. In these examples, the inlet airflow detector 308 is configured to detect one or more parameters indicative of the air flow of the inflowing air being received at the air inlet 102. In some examples, the second oven 300 comprises an inlet airflow temperature detector 310 configured to detect one or more parameters indicative of the temperature of air being received at the air inlet 102. In other words, the inlet airflow temperature detector 310 detects the temperature of the received make-up air. In these examples, the make-up airflow generator 302 may be controlled based on parameters detected by the inlet airflow detector 308 and the inlet airflow temperature detector 310.

For example, the temperature normalized inlet flow rate may be determined based on the one or more parameters detected by the inlet airflow detector 308, and the one or more parameters detected by the inlet airflow temperature detector 310. For example, the temperature normalized inlet flow rate may be determined in a similar manner to as described above in relation to the temperature normalized exhaust flow rate. In such examples, the make-up airflow generator 302 may be controlled such that the determined temperature normalized inlet flow rate (based on the measurements by the relevant detectors) becomes the same as, or similar to the temperature normalized exhaust flow rate (either as determined based on the described exhaust airflow detectors 304, 306, or otherwise).

For example, the processor may determine the temperature normalized inlet flow rate and compare it to the temperature normalized exhaust flow rate. Based on a difference between the determined temperature normalized inlet flow rate and the temperature normalized exhaust flow rate, the processor may control the operation of the make-up airflow generator 302 such that the difference is reduced or eliminated.

Reference is made herein to flow rates being the same or similar. It should be appreciated that the purpose of equalizing the temperature normalized flow rates of the incoming air and the outgoing air is to maintain a particular amount of air circulating within the internal circulation path 108. Accordingly, as used herein, “similar” means that the flow rates in question are similar enough (e.g., substantially the same within acceptable tolerances) such that the operation of the oven is not significantly affected due to an undesired reduction or increase in the amount of circulating air in the internal circulation path 108.

As previously described, the amount of circulating air that is exhausted may be controlled to maintain the circulating air within a contaminant threshold. The second set of examples provide ways in which the inflow of the make-up air is matched to the exhaust flow rate (which is, for example, set so as to maintain the system under the contaminant threshold) such that the circulating air which is exhausted to not exceed the contaminant threshold is appropriate replaced by contaminant free make-up air.

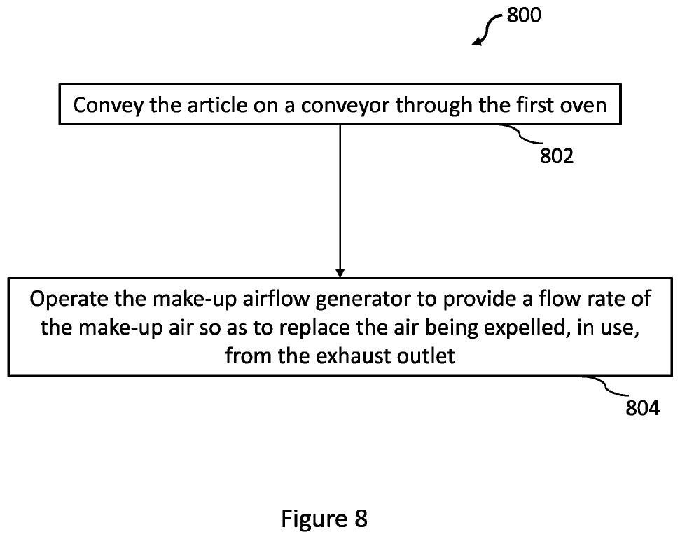

There may be provided a method, according to the second set of examples. For example, the method according to the second set of examples is for drying an article, and/or curing lacquer applied to an article (such as the article 116, for example). For example, the method may be for simply drying water present on the article. For example, the method may be for drying the article by removing (e.g., evaporating) other solvents off of the article. For example, the method may be for curing the lacquer. FIG. 8 is a flow diagram illustrating aspects of the second method 800 according to the second set of examples. At block 802 of the second method 800, the article 116 is conveyed on the conveyor 114 through the second oven 300. In these examples of the second method 800, the second oven 300 according to the second set of examples is used. In other words, in these examples, the make-up air flow path 104 comprises the make-up airflow generator 302 configured to urge the inflow of make-up air via the air inlet 102 at a flow rate so as to replace the air expelled from the exhaust outlet 112.

At block 804 of the second method 800, the make-up airflow generator 302 is operated to provide a flow rate of the make-up air so as to replace the air being expelled, in use, from the exhaust outlet 112. In this manner, there is provided a method of controlling an amount of air within the second oven 300 so that the circulating air which is exhausted is replaced by a corresponding amount of the make-up air. The use of the second method 800, for example, provides the advantages discussed above in relation to the second oven 300.

### Third Set of Examples

The third set of examples are more specific versions of the examples described previously in relation to FIG. 1. In some examples, the features of the third set of examples may also be combined with the features described in relation to the first set of examples and/or the features described in relation to the second set of examples. In these examples, in addition to the features previously discussed in relation to FIG. 1, the make-up airflow path 104 comprises an airflow generator configured to urge the inflow of make-up air via the air inlet 102. For example, the airflow generator in these examples, may be as described above in relation to the second set of examples. In these examples, the make-up airflow path 104 comprises a set of make-up air outlets configured to provide make-up air from the make-up airflow path 104 to a first location within the oven that is part of the internal circulation path 108 and/or a second location within the oven that is part of the internal circulation path 108, to thereby provide for the make-up airflow path 104 to exit into the internal circulation path 108. In these examples, the first location is towards an entry point of the conveyor 114 into the heated zone 408 of the oven, and the second location is towards an exit point of the conveyor from the heated zone 408.

In some examples, the set of make-up air outlets are configured to provide make-up air to the first location. In other examples, the set of make-up air outlets are configured to provide make-up air to the second location. In some examples, the set of make-up air outlets are configured to provide make-up air to both the first location and to the second location. Accordingly, the make-up air may be delivered to a desired position within the oven, for example, to be directed onto the conveyor 114 at a particular region of the heated zone 408.

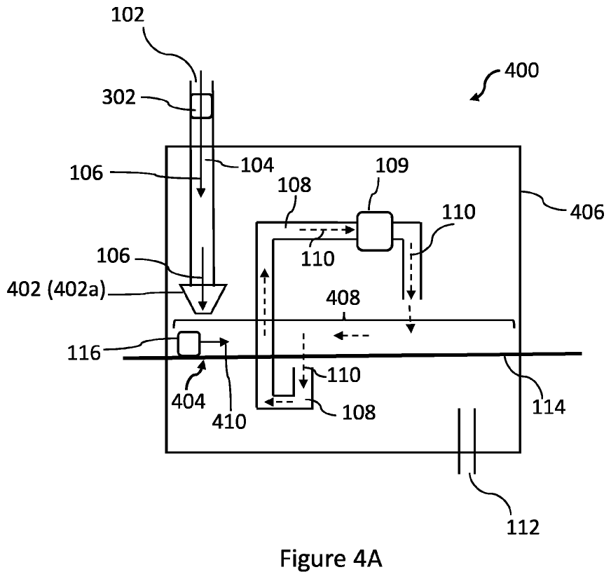

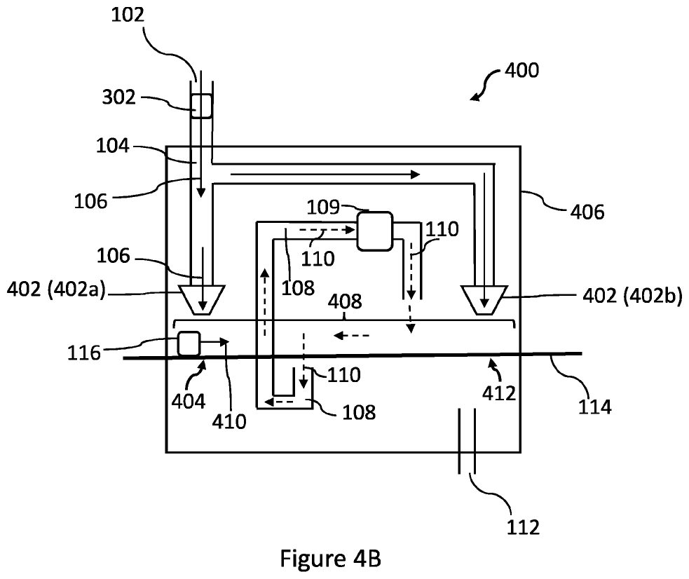

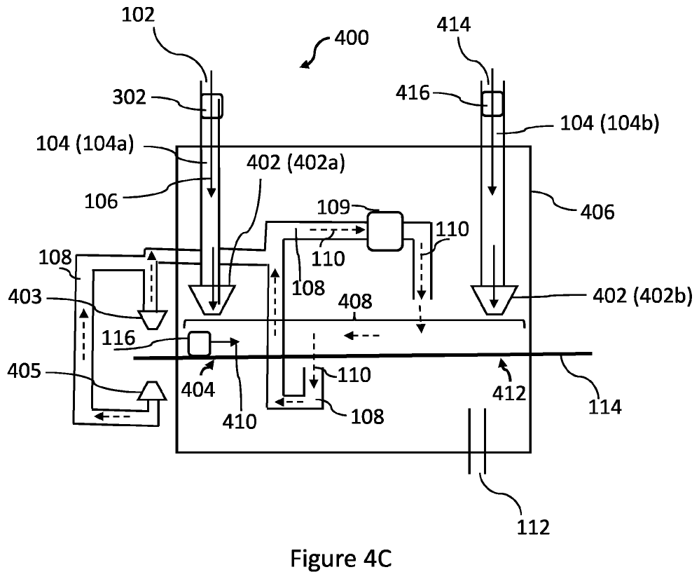

FIG. 4A is a first simplified schematic sketch of a third oven 400, according to the third set of examples. The third oven 400 represents more specific examples of the oven 100 shown in FIG. 1. In the examples of FIG. 4, there is provided a set of make-up air outlets 402.

In some examples, the set of make-up air outlets 402 comprises one make-up air outlet. In other examples, the set of make-up air outlets 402 comprises more than one make-up air outlet. In some examples, at least some of the make-up air outlets 402 are provided in the form of nozzles. In some examples, the set of make-up air outlets 402 comprises one or more nozzles configured to direct the make-up air onto the conveyor 114.

In the examples of FIG. 4A, the set of make-up air outlets 402 comprises one nozzle 402a (referred to hereafter as the first nozzle 402a) configured to direct the make-up air onto the conveyor 114. In the examples of FIG. 4A, the first nozzle 402a is configured to provide make-up air to the first location 404, which corresponds to a location near to where the conveyor 114 enters the third oven 400 in the transport direction 410. In other words, the first location 404 is towards an entry point of the conveyor 114 into the heated zone of the third oven 400. As shown in FIGS. 4A to 4C for example, the first location 404 is closer to the entry point of the conveyor 114 into the heated zone 408 than it is to the centre of the heated zone 408 of the third oven 400. As described, the heated zone 408 is the region of the third oven 400 surrounding the portion of the conveyor 114 inside the body 406 of the third oven 400. For example, the heated zone 408 is a region where the circulating air circulates. For example, the heated zone 408 is part of the internal circulation path 108. In these examples, the first nozzle 402a is configured to provide make-up air to the first location 404 by virtue of its position within the third oven 400.

Advantageously, by virtue of the first nozzle 402a being configured to direct the make-up air to the first location 404, the article 116 being conveyed encounters make-up air (not comprising significant contaminant(s)) first because at the first location, the make-up air has only just begun to mix with the circulating air present within the heated zone 408. For example, as the article 116 moves further into the heated zone 408, the concentration of contaminants may increase.

As described above, in some examples, the features of the first set of examples may be incorporated. For example, the third oven 400 may comprise the electric heater 202 (not shown in FIG. 4A) to provide heat to the make-up air before the make-up air exits into the internal circulation path 108. Therefore, in some examples, the make-up air may be pre-heated. In some such examples, the pre-heated make-up air may have a temperature higher than the ambient temperature, but lower than the temperature of the circulating air. In such examples, directing the pre-heated make-up air to the first location 404 provides that the article 116 experiences a more gradual increase in temperature as it enters the oven. For example, if pre-heated make-up air is not provided towards the first location 404, then the article 116 may experience a more extreme temperature gradient as it enters the heated zone 408. For example, the conveyor 114 conveys articles such as the article 116 through the heated zone 408 as indicated by the arrow 410. For example, a gradual increase in temperature may provide a better temperature curve when heating the article which in some cases benefits the during of the article, stops over cure and thus cuts down on excess contaminants and improves the finished cured product.

In some examples, the make-up air exiting via the set of make-up air outlets 402 towards the first and/or second location generates an air pressure at, or close the first location and/or the second location (as the case may be), respectively, which is greater than the ambient air pressure outside of the third oven 400. For example, the third oven 400 is open to the environment where the conveyor 114 enters and exits the body 406 of the third oven 400. For example, the body 406 may comprise an opening to receive the conveyor 114 at a first end (near the first location 404), and may comprise another opening at a second end, opposite to the first end, for the conveyor 114 to exit the body 406.

For example, because the third oven 400 is open to the environment near the first location 404 where the conveyor 114 enters the body 406, air may be drawn into the third oven 400 where the conveyor 114 enters the body 406. For example, when the circulating air is exhausted through the exhaust outlet 112, a negative pressure may be generated in the internal circulation path 108 in the heated zone 408, causing air to be drawn in. Such drawing in of air may not be desired. For example, the location and/or quantity of air being drawn in in this manner may not be well controlled. Also, in the particular examples where the electric heater 202 is provided, it is desired that the make-up air coming in to replace the exhausted air is pre-heated, and drawing in of colder ambient air may not be desired.

However, advantageously in the examples of FIG. 4A, the first nozzle 402a being configured to direct the make-up air to the first location 404 generates additional air pressure (greater than the ambient air pressure outside of the third oven 400) near the first location 404, and inhibits ambient air from being drawn in near the first location 404 due to said pressure. FIG. 4B is a second simplified schematic sketch of the third oven 400, according to the third set of examples. In the examples of FIG. 4B, the set of make-up air outlets 402 are configured to provide make-up air to both the first location 404 and to the second location 412. In these examples, the set of make-up air outlets 402 comprises the first nozzle 402a and a second nozzle 402b. The second nozzle 402b is positioned to provide make-up air to the second location 412 (towards where the conveyor 114 exits the third oven 400). As shown in FIGS. 4B and 4C for example, the second location 412 is closer to the exit point of the conveyor 114 out of the heated zone 408 than it is to the centre of the heated zone 408 the third oven 400.

In the examples of FIG. 4B, the second nozzle 402b being configured to direct the make-up air to the second location 412 also generates additional air pressure (greater than the ambient air pressure outside of the third oven 400) near the second location 412, and inhibits air from being drawn in near the second location 412 due to said pressure. In the examples of FIG. 4B, drawing in of ambient air is inhibited both near the first location 404 and the second location 412.

In this manner, control may be obtained over how/where the make-up air is delivered into the internal circulation path 108. Also, in this manner, the flow rate of the make-up air being delivered into the oven may be more finely controlled (by controlling the make-up airflow generator), for example. Also, in the examples where pre-heated make-up air is desired, inflow of ambient temperature air near the first location 404 can be avoided such that the temperature gradient (in the direction of arrow 410) within the heated zone 408 can be better controlled as the article 116 moves towards the centre of the heated zone 408 (in the transport direction 410). For example, the greatest temperature within the third oven 400 may be at, or near the centre of the heated zone 408. How gradually the temperature increases may be desired to be controlled in accordance with, for example, a lacquer applied to the article 116. For example, how gradually the temperature is desired to increase may depend on the thickness of the lacquer applied to the article 116 and/or the composition of the lacquer.

In some examples, there may be provided one or more extraction inlets near the first location 404 (which may be inside the body 406 or outside the body 406), and/or one or more extraction inlets near the second location 412 (which may be inside the body 406 or outside the body 406). For example, the extraction inlets are configured to extract air which attempts to escape the oven where the conveyor 114 enters the oven near the first location 404, and/or air which attempts to escape the oven where the conveyor 114 exits. For example, the extraction inlets are configured to extract air which attempts to enter the oven where the conveyor 114 enters the oven near the first location 404, and/or air which attempts to enter the oven where the conveyor 114 exits. The one or more extraction inlets (whether near the first location 404 or the second location 412) for part of the internal circulation path 108. For example, any air extracted by the one or more extraction inlets joins the internal circulation path. In the examples of FIG. 4C, there are shown extraction inlets labelled with numerals 403 and 405. Such extraction inlets 403, 405 may additionally, or alternatively be provided near the second location 412 (although not shown in FIG. 4C).

In the examples of FIG. 4B, controlled cooling of the article 116 may be achieved as the article 116 moves to the exit of the third oven 400. For example, a more gradual temperature gradient may be achieved between the peak temperature in the heated zone 408 and the temperatures outside the third oven 400 as the article 116 exits the body 406, due to the delivery at the second location 412 of the pre-heated make-up air (in examples where there is an electric heater 202). Furthermore, it may be desired that the article 116 be exposed to make-up air (which does not contain significant contaminant(s)) sooner than when the article 116 exits the third oven 400. For example, exposing the article 116 to relatively contaminant free air sooner may improve the quality of the lacquer on the article 116. The arrangement of the examples of FIG. 4B provide these advantages.

In the examples of FIG. 4B, the make-up airflow path 104 receives make-up air from the air inlet 102 and then splits into different passageways such that the make-up air can be provided to different locations within the third oven 400. However, in the examples of FIG. 4B, the different passageways of the make-up airflow path 104 receive air from the same air inlet 102. FIG. 4C is a third simplified schematic sketch of the third oven 400, according to the third set of examples. In some examples, the air inlet 102 is a first air inlet, and the third oven 400 comprises a second air inlet 414 configured to receive an inflow of make-up air into the make-up airflow path 104.

In these examples, the make-airflow path 104 comprises a first make-up air passageway 104a which receives make-up air from the first air inlet 102, and a second make-up air passageway 104b which receives make-up air from the second air inlet 414. As referred to herein, the term make-up airflow path may include one or more different passageways for air to flow and is not limited to a single passageway.

In some examples (such as that of FIG. 4C), the set of make-up air outlets 402 is configured to provide make-up air from the make-up airflow path to both the first location 404 and to the second location 412. In some such examples, the first make-up air passageway 104a leads to the first location 404 and the second make-up air passageway 104b leads to the second location 412. In other words, there is provided a first air inlet 102 to provide make-up air to the first make-up air passageway 104a (of the make-up airflow path 104) leading to first nozzle 402a, which directs the make-up air to the first location 404. For example, there is also provided a second air inlet 414 to provide make-up air to the second make-up air passageway 104b (of the make-up airflow path 104) leading to the second nozzle 402b, which directs the make-up air to the second location 412. In examples, there may be provided a plurality of nozzles for directing the make-up air to the first location 404 and/or there may be provided a plurality of nozzles for directing the make-up air to the second location 412.

However, in some examples, the set of make-up air outlets 402 may be configured to provide make-up air from the make-up airflow path 104 to only one of the first location 404 or the second location 412. In these examples, the third oven 400 may still comprise the first air inlet 102 providing make-up air to the first make-up air passageway, and the second air inlet 414 providing air to the second make-up air passageway 104b. However, the first and second make-up air passageways 104a, 104b may meet (join together) before the make-up air flowing in each reaches the set of make-up air outlets 402. The particular configuration used may depend on the outside environment of the third oven 400 (from which the make-up air is to be collected), the desired quantity of make-up air, the desired delivery configuration of the make-up air within the oven, etc., for example.

In examples comprising the second air inlet 414, the previously described make-up airflow generator 302 may be a first make-up airflow generator 302, and there may additionally be provided a second make-up airflow generator 416 configured to urge the inflow of make-up air via the second air inlet 414.

As described, the features of the third set of examples may be combined with the features described with respect to any of the other examples. In examples where the flow rate of the inflowing make-up air is controlled so as to replace the air expelled from the exhaust outlet 112, both the first make-up airflow generator 302 and the second make-up airflow generator 416 may be controlled to achieve this. For example, both the first make-up airflow generator 302 and the second make-up airflow generator 416 may be controlled to provide a total temperature normalized inlet flow rate of the inflow being received at both the first air inlet 102 and the second air inlet 414, which is the same as, or similar to a temperature normalized exhaust flow rate of air being expelled via the exhaust outlet 112.

For example, the previously discussed inlet airflow detector 308 may be a first inlet speed detector associated with the first air inlet 102, and the previously discussed inlet airflow temperature detector 310 may be a first inlet temperature detector associated with the first air inlet 102. For example, there may also be provided a second inlet speed detector associated with the second air inlet 414 to function similarly to the first inlet airflow detector 308, but in relation to the second air inlet 414. For example, there may also be provided a second inlet temperature detector associated with the second air inlet 414 to function similarly to the first inlet airflow temperature detector 310, but in relation to the second air inlet 414 (these detectors are not shown in FIG. 4C). For example, the temperature normalized inlet flow rate of the first air inlet 102 may be summed with the temperature normalized inlet flow rate of the second air inlet 414 to arrive at the total temperature normalized inlet flow rate, which may be compared with the temperature normalized exhaust flow rate, as previously described.

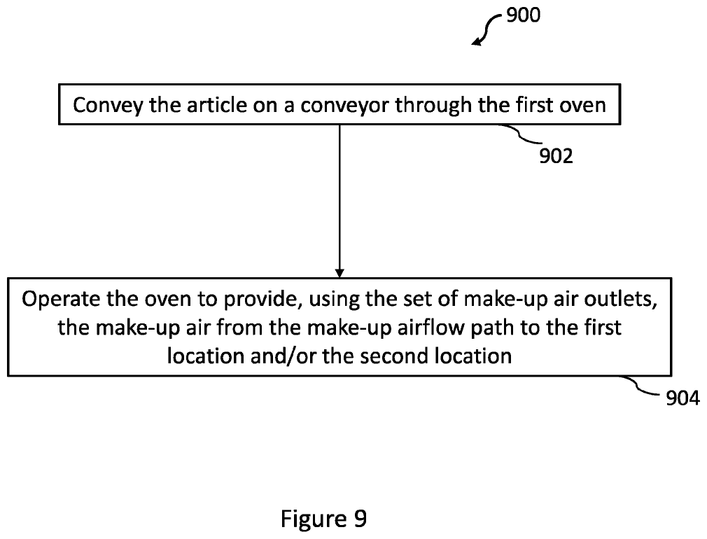

There may be provided a method, according to the third set of examples. For example, the method according to the third set of examples is for drying an article, and/or curing lacquer applied to an article (such as the article 116, for example). For example, the method may be for simply drying water present on the article. For example, the method may be for drying the article by removing (e.g., evaporating) other solvents off of the article. For example, the method may be for curing the lacquer. FIG. 9 is a flow diagram illustrating aspects of the third method 900 according to the third set of examples. At block 902 of the third method 900, the article 116 is conveyed on the conveyor 114 through the third oven 400. In these examples of the third method 900, the third oven 400 according to the third set of examples is used. In other words, in these examples, the make-up air flow path 104 comprises: the make-up airflow generator 302 configured to urge the inflow of make-up air via the air inlet 102; and the set of make-up air outlets 402 configured to provide the make-up air from the make-up airflow path 104 to the first location 404 within the third oven 400 that is part of the internal circulation path 108 and/or the second location 412 within the third oven 400 that is part of the internal circulation path 108, to thereby provide for the make-up airflow path to exit into the internal circulation path 108. In these examples of the third method 900, the first location 404 is towards an entry point of the conveyor 114 into the heated zone 408 of the third oven 400, and the second location 412 is towards an exit point of the conveyor 114 from the heated zone 408.

At block 904 of the third method 900, the third oven 400 is operated to provide, using the set of make-up air outlets 402, the make-up air from the make-up air flow path 104 to the first location 404 and/or the second location 412. In this manner, there is provided a method of providing the make-up air directly to particular location(s) within the third oven 400.

### Fourth Set of Examples

The fourth set of examples are more specific versions of the examples described previously in relation to FIG. 1. In some examples, the features of the fourth set of examples may also be combined with the features of the first set of examples and/or the features of the second set of examples and/or the features of the third set of examples. In these examples, in addition to the features previously described in relation to FIG. 1, the make-up airflow path 104 comprises a set of make-up air outlets to allow the make-up air to exit the make-up airflow path 104. In these examples, the set of make-up air outlets comprises one or more nozzles configured to direct the make-up air onto the conveyor 114. For example, the set of make-up air outlets of these examples may include the first and/or the second nozzle 402a, 402b described above in relation to the third set of examples. In the following description, the same reference numeral “402” is used for the set of make-up air outlets as in the case of the third set of examples. In these examples, the set of make-up air outlets also comprises an internal circulation path inlet. The internal circulation path inlet is configured to receive make-up air from the make-up airflow path 104 at a location along the internal circulation path 108 such that the make-up air mixes with the circulating air before being projected towards the conveyor 114.

For example, the internal circulation path inlet provides the make-up air to the internal circulation path 108 somewhere other than in the heated zone 408 where the conveyor 114 is intended to be positioned. For example, the internal circulation path inlet may provide the make-up air to the one or more passages of the internal circulation path 108 in a manner so that the make-up air mixes with the circulating air before reaching the heated zone 408. For example, the internal circulation path inlet may be positioned with respect to a passageway of the internal circulation path 108 away from where said passageway exits into the heated zone 408.

In these examples, the make-up airflow path 104 comprises a valve configured to control an amount of the make-up air allowed to enter the internal circulation path 108 via the internal circulation path inlet. As described, the set of make-up air outlets 402 may comprise, for example, nozzles which direct the make-up air onto the conveyor 114. Providing the valve for controlling the make-up air exiting into the internal circulation path 108 at different points provides control over the flow of the make-up air within the oven.

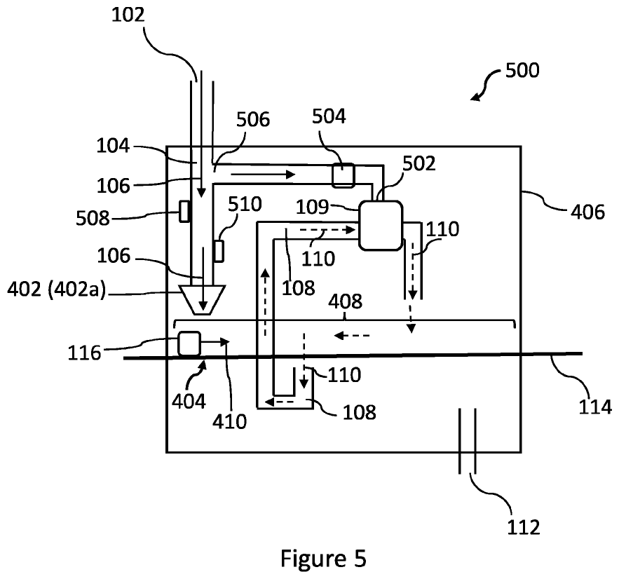

FIG. 5 is a simplified schematic sketch of a fourth oven 500, according to the fourth set of examples. the fourth oven 500 represents more specific examples of the oven 100 shown in FIG. 1.

In the examples of FIG. 5, the set of make-up air outlets 402 comprises the first nozzle 402a and the internal circulation path inlet 502. In these examples, the make-up airflow path splits into different passageways such that the make-up air is guided to the first nozzle 402a and to the internal circulation path inlet 502. In the examples of FIG. 5, there is a make-up air junction 506 at which the make-up airflow path 104 splits into different passageways.

In these examples, there is provided the valve 504. The valve 504 is positioned in the passageway leading to the internal circulation path inlet 502. For example, when the valve 504 is open, the make-up air is permitted to flow to the internal circulation path inlet 502. However, when the valve 504 is fully closed, the make-up air is prevented (or severely inhibited) from flowing to the internal circulation path inlet 502. The valve 504 may be opened to varying different extents in order to allow different amounts of the make-up air to flow to the internal circulation path inlet 502. In some examples, the valve 504 may allow for a number of discrete steps between fully open and fully closed. In other examples, the valve 504 may allow for continuous adjustment between fully open and fully closed. How the valve 504 is configured may depend on the desired granularity of the control over how much of the make-up air is to flow to the internal circulation path inlet 502.

In some examples, the fourth oven 500 comprises a nozzle temperature detector positioned upstream of the one or more nozzles and configured to detect one or more parameters indicative of the temperature of the make-up air passing through the one or more nozzles. In the examples of FIG. 5, there is provided the nozzle temperature detector 508. For example, the nozzle temperature detector 508 is positioned so as to measure the temperature of the make-up air about to exit via the first nozzle 402a. In the examples of FIG. 5, the nozzle temperature detector 508 is positioned after (downstream of) the junction 506.

In examples where there is provided the electric heater 202 to provide heat to the make-up air before the make-up air exits into the internal circulation path 108, the nozzle temperature detector 508 is position downstream of said electric heater. This is so that the nozzle temperature detector 508 measures the temperature of the make-up air after it has already been pre-heated by the electric heater 202.

In some examples, the fourth oven 500 comprises a nozzle airflow detector positioned upstream of the one or more nozzles and configured to detect one or more parameters indicative of the air flow of the make-up air approaching the one or more nozzles. In the examples of FIG. 5, there is provided the nozzle airflow detector 510. The nozzle airflow detector 510 is positioned after the junction 506 such that it detects the respective one or more parameters associated with the make-up air taking into account the make-up air flowing to the internal circulation path inlet 502 through the valve 504. It will be appreciated that the flow rate of the make-up air through the first nozzle 402a will depend on how much of the make-up air is allowed to flow to the internal circulation path inlet 502 through the valve 504.

In some examples, the valve 504 is controlled based on a nozzle speed of the make-up air passing through the one or more nozzles, wherein the nozzle speed is determined based on the one or more parameters detected by the nozzle temperature detector, and the one or more parameters detected by the nozzle airflow detector. The nozzle speed depends on the amount of air allowed through the valve 504. Accordingly, by controlling the valve 504, the nozzle speed through the nozzles can be controlled.

For example, a temperature normalized flow rate of the make-up air immediately upstream of the one or more nozzles may be determined based on the detections made by the nozzle temperature detector and the nozzle airflow detector in a similar manner to the determination of the described temperature normalized inlet flow rate and the temperature normalized exhaust flow rate. For example, the area of the duct immediately upstream of the one or more nozzles is used to determined the associated flow rate (using a speed value, in the manner described above). The one or more nozzles may have a different cross-sectional area at the nozzle outlet through which the make-up air passes. Taking the example of one nozzle, the temperature normalized flow rate of the make-up air immediately upstream of the nozzle, and the cross-sectional area of the nozzle outlet may be used to determine the nozzle speed. For example, the temperature normalized flow rate of the make-up air immediately upstream of the nozzle is divided by the cross-sectional area of the nozzle outlet to determine the speed of the make-up air (in units of m/s) leaving the nozzle.

In the examples of FIG. 5, there is shown just one nozzle to direct the make-up air onto the conveyor 114. Accordingly, it is appropriate to position the nozzle airflow detector 510 just before said nozzle to determine the speed of the make-up air flowing through said nozzle. In other examples, if there is more than one nozzle for directing the make-up air onto the conveyor 114, there may be provided a nozzle airflow detector appropriately positioned for each such nozzle.

In the examples of FIG. 5, the is the first nozzle 402a and the valve 504 is controlled based on the nozzle speed of the make-up air passing through the first nozzle 402a. In some examples where there is more than one nozzle, the valve 504 may be controlled based on the respective nozzle speed associated with each of those nozzles. However, in some examples where there is more than one nozzle, the valve 504 may still be controlled based on the nozzle speed associated with one (or a subset) of the nozzles. For example, it may be desired to control the temperature normalized flow rate associated with only some of the nozzles, and the valve 504 may be controlled according to the temperature normalized flow rate determined for just those nozzles.

As previously described, a temperature normalized flow rate refers to speed of airflow which has been normalized by the temperature of said air to give an indication of an amount of airflow independent of temperature and associated density variations. In some examples, the valve 504 is controlled such that the nozzle speed (of the one or more nozzles for which such control is desired) does not exceed a nozzle speed threshold.

Taking the examples of FIG. 5, it may be desired that the nozzle speed does not exceed the nozzle speed threshold for the first nozzle 402a. For example, the first nozzle 402a is configured to direct the make-up air onto the conveyor 114 as shown in FIG. 5 (and other Figures). When the article 116 is aligned with the first nozzle 402a, the first nozzle 402a directs the make-up air onto the article 116. If the speed of the air directed onto the article 116 is too high (depending on the shape of the article 116), the flow may knock the article 116 over. It may not be desired that the article 116 be knocked over on the conveyor 114 (for various reasons such as disruption of uncured lacquer, problems with later manufacturing steps, etc., as those skilled in the art will appreciate).

For example, the nozzle speed threshold may be selected based on the shape of the article 116 being treated in the fourth oven 500. As an example, for articles having a wider base, a higher nozzle speed threshold may be appropriate, whereas for articles with relatively narrower bases, a relatively lower nozzle speed threshold may be appropriate. The valve 504 may be opened/closed to different degrees to maintain the nozzle speed under the particular desired threshold. In some examples, the nozzle speed threshold is 11 m/s. In some examples, the nozzle speed threshold is between 4 m/s and 7 m/s. In some specific examples, the nozzle speed threshold is 7 m/s.

In examples comprising the make-up airflow generator 302, control over the nozzle speed may be particularly advantageous because the make-up air may potentially be delivered at greater flow rates due to the action of the make-up airflow generator 302, for example.

As an example, the valve 504 may be controlled by the described processor (which is either part of the oven or external to it, for example).

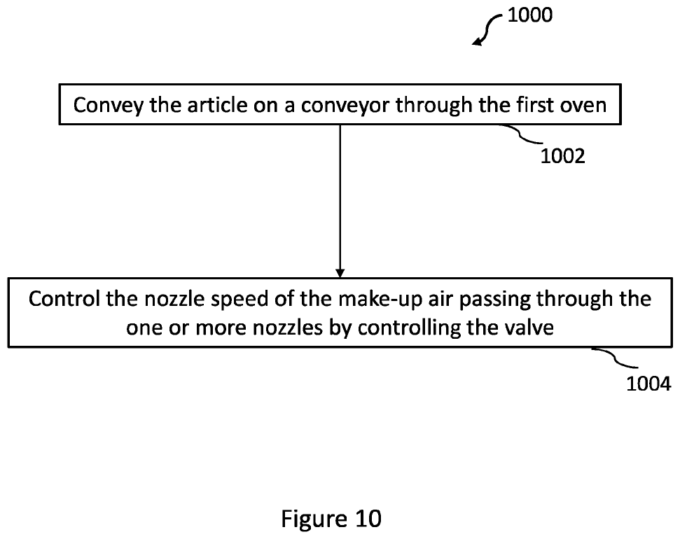

There may be provided a method, according to the fourth set of examples. For example, the method according to the fourth set of examples is for drying an article, and/or curing lacquer applied to an article (such as the article 116, for example). For example, the method may be for simply drying water present on the article. For example, the method may be for drying the article by removing (e.g., evaporating) other solvents off of the article. For example, the method may be for curing the lacquer. FIG. 10 is a flow diagram illustrating aspects of the fourth method 1000 according to the fourth set of examples. At block 1002 of the fourth method 1000, the article 116 is conveyed on the conveyor 114 through the fourth oven 500. In these examples of the fourth method 1000, the fourth oven 500 according to the fourth set of examples is used.

At block 1004 of the fourth method 1000, the nozzle speed of the make-up air passing through the one or more nozzles is controlled by controlling the valve 504. In this manner, there is provided a method in which the flow rate of the make-up air directed onto the conveyor is controlled.

### Oven System

In some examples, there may be provided an oven system for applying heat to an article on a conveyor. the oven system may comprise a plurality of ovens according to any of the examples described herein. Furthermore, the oven system may comprise a conveyor configured to convey the article in a transport direction. For example, the oven system comprises the conveyor 114 shown in FIGS. 1 to 5 configured to convey the article 116 in the transport direction 410.

In these examples, the plurality of ovens are arranged linearly along the transport direction, and the conveyor is configured to convey the article through a respective heated zone of each of the plurality of ovens. For example, two or more ovens according to any of the described examples may be arranged linearly along the transport direction and configured with the conveyor such that a respective portion of the conveyor is position within a heated zone of each of those ovens. In the examples described herein, the conveyor provides for articles to be passed through the described ovens such that the articles can be heat treated within the ovens.

For example, two or more linearly arranged ovens may include ovens according to different examples described herein. As an example, the system may comprise a first oven according to the first set of examples (comprising the electric heater), and a second oven according to the examples of FIG. 4B. The features chosen for each of the ovens in the system may depend, for example, on the particular heat treatment/heat treatment process that is to be applied to the article. For example, each oven may operate so as to provide circulating air at different temperatures to one another, according to a desired heat treatment.

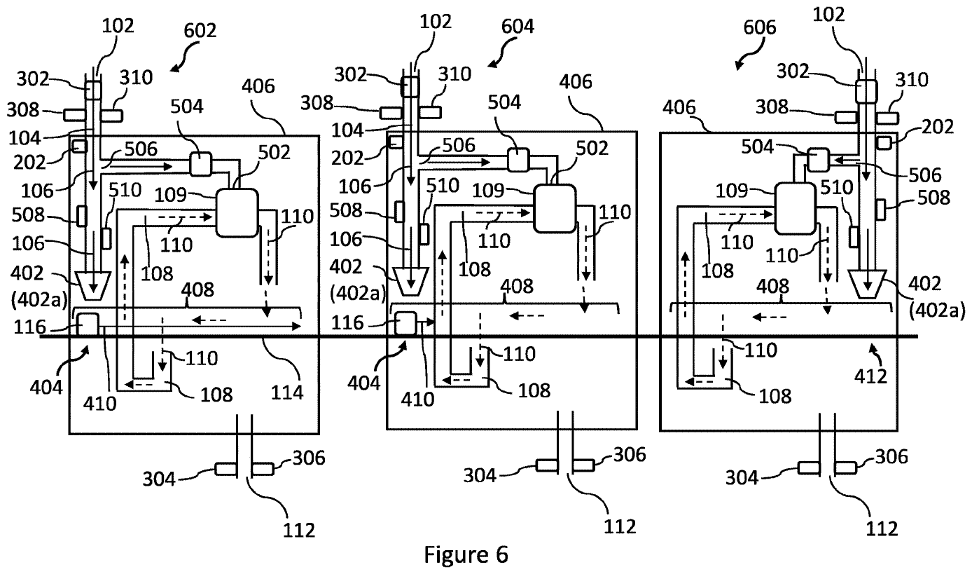

FIG. 6 is a simplified schematic sketch of an oven system 600, according to examples. In these examples, there is provided a first system oven 602, a second system oven 604 and a third system oven 606. In these examples, like features present within these various system ovens 602, 604, 606 are labelled with the same reference numerals as used for like feature in the previously described examples. In these examples, in each of the first, second and third system ovens 602, 604, 606, the make-up airflow path 104 comprises an electric heater 202 to provide heat to the make-up air flowing in the make-up airflow path before the make-up air exits into the internal circulation path 108. In these examples, in each of the first, second and third system ovens 602, 604, 606, the make-up airflow path 104 comprises a make-up airflow generator 302 configured to urge the inflow of make-up air via the air inlet 102 at a flow rate so as to replace the air expelled from the exhaust outlet 112.

In these examples, in each of the first, second and third system ovens 602, 604, 606, the make-up airflow path 104 comprises a set of make-up air outlets configured to provide make-up air from the make-up airflow path 104 to a first location and/or a second location, to thereby provide for the make-up airflow path 104 to exit into the internal circulation path (where the first location is towards an entry point of the conveyor 114 into a respective heated zone of each oven, and the second location is towards an exit point of the conveyor from the respective heated zone of each oven). In the case of the first and second system ovens 602, 604, the set of make-up air outlets 402 comprises a nozzle 402a configured to provide make-up air from the make-up airflow path 104 to the respective first location 404 of the conveyor 114. As referred to herein, there is a “first location” with respect to each of the ovens in question. The first location for the first system oven 602 is towards an entry point of the conveyor 114 into the first system oven 602. The first location for the second system oven 604 is a different location 114 compared to the first location for the first system oven 602. The first location for the second system oven 604 is towards an entry point of the conveyor 114 into the second system oven 604.

In these examples, in the first and second system ovens 602, 604, the make-up air is directed towards the first location 404 of each respective oven. However, in the case of the third system oven 606 of these examples, the set of make-up air outlets is configured to provide the make-up air to the second location 412, which is towards the exit of the conveyor from the third system oven 606 in the direction 410. For example, the third system oven 606 comprises a nozzle 402a positioned so as to direct the make-up air towards the second location 412 within the third system oven 606.

In these examples, it may be desired that the article 116 experience a gradual increase in temperature by first encountering pre-heated make-up air from the nozzle 402a of the first system oven 602. As an example, arranging two or more ovens linearly in this manner may provide for applying varying temperatures to the article 116, as the article 116 is conveyed on the conveyor 114 through all the linearly arranged system ovens 602, 604, 606. For example, the peak temperature in the second system oven 604 may be higher than the peak temperature within the first system oven 602. For example, the nozzle 402a of the second system oven 604 may provide the make-up air taken in by the respective inlet 102 of the second system oven 604 to the first location 404 of the second system oven 604 at a temperature higher than the peak temperature within the first system oven 602. This temperature may also be lower than the peak temperature within the second system oven 604 so as to further pre-heat the article 116 before the article 116 experiences higher temperatures within the second system oven 604.

For example, the peak temperature within the third system oven 606 may be higher than the peak temperature in the second system oven 604. For example, the nozzle 402b of the third system oven 606 is positioned to direct the make-up air pre-heated by the electric heater 202 of the third system oven 606 to the second location 412 of the third system oven 606. For example, delivery of the pre-heated make up air at the second location of the third system oven 606 may provide controlled/gradual cooling of the article 116 as the article 116 exits the third system oven 606 and out into the external environment where the ambient temperature may be significantly cooler than the temperature within the third system oven 606.

In these examples, in each of the first, second and third system ovens 602, 604, 606, the make-up airflow path 104 comprises a set of make-up air outlets, as discussed, which comprise one or more nozzles configured to direct the make-up air to exit the respective make-up airflow path. In these examples, in each of the first, second and third system ovens 602, 604, 606, the make-up airflow path 104 also comprises an internal circulation path inlet 502 configured to receive the make-up air from the make-up airflow path at a location along the internal circulation path 108 such that the make-up air mixes with the circulating air before being projected towards the conveyor. In these examples, in each of the first, second and third system ovens 602, 604, 606, the make-up airflow path 104 also comprises a valve 504 configured to control an amount of the make-up air allowed to enter the internal circulation path 108 via the internal circulation path inlet 502.

Accordingly, in these examples, each of the first, second and third system ovens 602, 604, 606 comprises features from each of the first, second, third and fourth set of examples. In examples, the features of any one or more of the first, second, third and fourth set of examples may be omitted from any one or more of the first, second and third system ovens 602, 604, 606. In this manner, a highly configurable oven system may be provided for applying heat to articles.

Although not shown in FIG. 6, in some example, the first system oven 602 may comprise extraction inlets near the first location 404 (which may be inside the body 406 or outside the body 406). Although not shown in FIG. 6, in some example, the third system oven 606 may comprise one or more extraction inlets near the second location 412 (which may be inside the body 406 or outside the body 406).

In the above description, various specific examples are described. Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing example(s). The invention extends to any novel one, or any novel combination, of the features disclosed in this specification (including any accompanying claims, abstract and drawings), or to any novel one, or any novel combination, of the steps of any method or process so disclosed.

1. An oven for applying heat to an article on a conveyor, the oven comprising:
an air inlet configured to receive an inflow of make-up air into a make-up airflow path;
an internal circulation path comprising a main heat source, wherein air circulates within the internal circulation path; and
an exhaust outlet configured to expel air out of the oven from the internal circulation path so as to control a quantity of contaminants flowing within the internal circulation path,
wherein:
the make-up airflow path exits into the internal circulation path; and
the make-up airflow path comprises an electric heater to provide heat to the make-up air flowing in the make-up airflow path before the make-up air exits into the internal circulation path.

2. The oven according to claim 1, wherein:
the main heat source is a gas burner chamber in the internal circulation path through which the circulating air passes.

3. The oven according to claim 2, wherein:
the gas burner chamber is supplied with a fuel gas comprising hydrogen gas, and the gas burner chamber is configured to generate a flame exposed to the circulating air.

4. The oven according to claim 3, wherein:
the fuel gas is a mixture of hydrogen gas and natural gas, or the fuel gas is a mixture of hydrogen gas and liquid petroleum gas.

5. The oven according to claim 1, wherein:
the electric heater is controlled to provide heat directly to the make-up air such that the make-up air is at a temperature higher than ambient temperature before the make-up air exits into the internal circulation path.

6. The oven according to claim 1, wherein:
the make-up airflow path comprises a make-up airflow generator configured to urge the inflow of make-up air via the air inlet,
wherein, optionally:
the make-up airflow generator is configured to urge the inflow of make-up air at a flow rate so as to replace the air expelled from the exhaust outlet.

7. (canceled)

8. The oven according to claim 7, wherein:
the make-up airflow generator is configured to be controlled to provide a temperature normalized inlet flow rate of the inflow being received at the air inlet, which is the same as, or similar to a temperature normalized exhaust flow rate of air being expelled via the exhaust outlet.

9. The oven according to claim 8, comprising:
an exhaust airflow detector configured to detect one or more parameters indicative of the air flow of air being expelled via the exhaust outlet; and
an exhaust airflow temperature detector configured to detect one or more parameters indicative of the temperature of air being expelled via the exhaust outlet,
wherein, the temperature normalized exhaust flow rate is determined based on the one or more parameters detected by the exhaust airflow detector, and the one or more parameters detected by the exhaust airflow temperature detector.

10. The oven according to claim 8, comprising:
an inlet airflow detector configured to detect one or more parameters indicative of the air flow of the inflowing air being received at the air inlet; and
an inlet airflow temperature detector configured to detect one or more parameters indicative of the temperature of air being received at the air inlet,
wherein, the temperature normalized inlet flow rate is determined based on the one or more parameters detected by the inlet airflow detector, and the one or more parameters detected by the inlet airflow temperature detector.

11. The oven according to claim 6, wherein:
the make-up airflow path comprises a set of make-up air outlets configured to provide make-up air from the make-up airflow path to a first location within the oven that is part of the internal circulation path and/or a second location within the oven that is part of the internal circulation path, to thereby provide for the make-up airflow path to exit into the internal circulation path,
wherein:
the first location is towards an entry point of the conveyor into a heated zone of the oven, and the second location is towards an exit point of the conveyor from the heated zone.

12. The oven according to claim 11, wherein:
the set of make-up air outlets comprises one or more nozzles configured to direct the make-up air onto the conveyor.

13. The oven according to claim 11 wherein:
the make-up air exiting via the set of make-up air outlets towards the first and/or second location generates an air pressure at, or close to the first location and/or the second location, respectively, which is greater than the ambient air pressure outside of the oven.

14. The oven according to claim 11, wherein:
the air inlet is a first air inlet, and the oven comprises a second air inlet configured to receive an inflow of make-up air into the make-up air flow path; and the make-up air flow path comprises a first make-up air passageway which receives make-up air from the first air inlet, and a second make-up air passageway which receives make-up air from the second air inlet,
wherein, optionally:
the set of make-up air outlets is configured to provide make-up air from the make-up airflow path to both the first location and to the second location; and
the first make-up air passageway leads to the first location and the second make-up air passageway leads to the second location.

15. (canceled)

16. The oven according to claim 1, wherein the make-up airflow path comprises:
a set of make-up air outlets to allow the make-up air to exit the make-up airflow path, the set of make-up air outlets comprising:
one or more nozzles configured to direct the make-up air onto the conveyor; and
an internal circulation path inlet configured to receive make-up air from the make-up airflow path at a location along the internal circulation path such that the make-up air mixes with the circulating air before being projected towards the conveyor, and
the make-up airflow path comprises a valve configured to control an amount of makeup air allowed to enter the internal circulation path via the internal circulation path inlet.

17. The oven according to claim 16, comprising:
a nozzle temperature detector positioned upstream of the one or more nozzles and configured to detect one or more parameters indicative of the temperature of the make-up air passing through the one or more nozzles; and
a nozzle airflow detector positioned upstream of the one or more nozzles and configured to detect one or more parameters indicative of the air flow of the make-up air approaching the one or more nozzles,
wherein, optionally:
the valve is controlled based on a nozzle speed of the make-up air passing through the one or more nozzles, wherein the nozzle speed is determined based on the one or more parameters detected by the nozzle temperature detector, and the one or more parameters detected by the nozzle airflow detector;
wherein, optionally:
the valve is controlled such that the nozzle speed does not exceed a nozzle speed threshold;
wherein, optionally:
the nozzle speed threshold is between 4 m/s and 11 m/s.

18. (canceled)

19. (canceled)

20. (canceled)

21. An oven system for applying heat to an article on a conveyor, the oven system comprising:
a plurality of ovens according to claim 1; and
a conveyor configured to convey the article in a first direction,
wherein:
the plurality of ovens are arranged linearly along the first direction; and the conveyor is configured to convey the article through a respective heated zone of each of the plurality of ovens.

22. A method for drying an article, and/or curing lacquer applied to an article, the method comprising:
conveying the article on a conveyor through an oven, the oven comprising:
an air inlet configured to receive an inflow of make-up air into a make-up airflow path;
an internal circulation path comprising a main heat source, wherein air circulates within the internal circulation path; and
an exhaust outlet configured to expel air out of the oven from the internal circulation path so as to control a quantity of contaminants flowing within the internal circulation path,
wherein:
the make-up airflow path exits into the internal circulation path; and
the make-up airflow path comprises an electric heater to provide heat to the make-up air flowing in the make-up airflow path before the make-up air exits into the internal circulation path; and
operating the electric heater to provide heat to the make-up air being received through the air inlet, before the make-up air exits into the internal circulation path.

23. The method according to claim 22, wherein:
the make-up airflow path of the oven comprises a make-up airflow generator configured to urge the inflow of make-up air via the air inlet at a flow rate so as to replace the air expelled from the exhaust outlet; and
the method comprises operating the make-up airflow generator to provide a flow rate of the make-up air so as to replace the air being expelled, in use, from the exhaust outlet.

24. The method according to claim 22, wherein:
the make-up airflow path of the oven comprises a set of make-up air outlets configured to provide make-up air from the make-up airflow path to a first location within the oven that is part of the internal circulation path and/or a second location within the oven that is part of the internal circulation path, to thereby provide for the make-up airflow path to exit into the internal circulation path,
wherein:
the first location is towards an entry point of the conveyor into a heated zone of the oven, and the second location is towards an exit point of the conveyor from the heated zone; and
the method comprises operating the oven to provide, using the set of make-up air outlets, the make-up air from the make-up airflow path to the first location and/or the second location.

25. The method according to claim 22, wherein:
the make-up airflow path of the oven comprises:
a set of make-up air outlets to allow the make-up air to exit the make-up airflow path, the set of make-up air outlets comprising:
one or more nozzles configured to direct the make-up air onto the conveyor; and
an internal circulation path inlet configured to receive make-up air from the make-up airflow path at a location along the internal circulation path such that the make-up air mixes with the circulating air before being projected towards the conveyor, and
the make-up airflow path of the oven comprises a valve configured to control an amount of make-up air allowed to enter the internal circulation path via the internal circulation path inlet,
the method further comprising:
controlling a nozzle speed of the make-up air passing through the one or more nozzles by controlling the valve.
